(19) United States
(12) Patent Application Publication
(10) Pub. No.: US 2006/0283095 A1
(43) Pub. Date: Dec. 21, 2006

(54) Fumed silica to colloidal silica conversion process

(75) Inventors: Deepak Mahulikar, Madison, CT (US); Yuhu Wang, Ann Arbor, MI (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Planar Solutions, LLC

(21) Appl. No.: 11/152,873

(22) Filed: Jun. 15, 2005

(51) Int. Cl. C01B 33/20; C01B 33/141; C09K 3/14; C01B 33/12

(52) U.S. Cl. 51/308; 423/335; 516/81; 516/79

(57) ABSTRACT

A method of manufacturing a colloidal silica dispersion, by dissolving a fumed silica in an aqueous solvent having an alkali metal hydroxide to produce an alkaline silicate solution; removing the alkali metal via ion exchange to produce a silicic acid solution; adjusting the temperature, concentration and pH of the silicic acid solution to values sufficient to initiate nucleation and particle growth at elevated temperatures; and cooling the silicic acid solution at a rate sufficient to produce the colloidal silica dispersion. The colloidal silica particles in the colloidal silica dispersion have a mean particle size about 2 nm to about 100 nm. Also provided is a method of chemical mechanical polishing a surface of a substrate by contacting the substrate and a composition having a plurality of colloidal silica particles according to the present invention and a medium for suspending the particles. The contacting is carried out at a temperature and for a period of time sufficient to planarize the substrate.

### BACKGROUND OF THE INVENTION

1. Field of the Invention

The present invention relates to a method of manufacturing a high purity colloidal silica dispersion. More particularly, the invention relates to method of manufacturing colloidal silica dispersion using fumed silica as the starting material. The present invention also relates to a method of chemical mechanical polishing the surface of a substrate using colloidal silica prepared according to the present invention.

2. Description of Related Art

The most common process for the preparation of colloidal silica in industry is to prepare colloidal silica particles from water glass made by fusion of natural silica sands with sodium carbonate at temperature less than 1200° C. After fusion, the fused sodium silicate is quenched and completely dissolved in water, forming water glass that is highly caustic. To process colloidal silica, the water glass is further passed through a strong acidic resin bed or column for ion exchange and converted into silicic acid. The silicic acid, normally around pH 2-3, is then placed in a container, the pH adjusted to about 8 using alkali for stabilization, and then heated to an elevated temperature, 80-100° C. for particle formation.

Depending upon the processing condition, the particle size distribution of the final product can be manipulated and controlled to be from 5 nm to about 100 nm or less. Because of the nature of the raw material, silica sands, however, the final colloidal silica from this process has more or less trace metals, such as Fe, Al, and Na, from 100 ppm to 1000 ppm or less.

Although ion exchange can remove certain amount of trace metals, impurities lower than 100 ppm is very difficult to achieve with this process even using the highest quality of natural SiO₂ (see, for example, “The Chemistry of Silica,” by Ralph K. Iler, John Wiley & Sons, Inc., Ed. (1979), and U.S. Pat. No. 3,947,376).

Another approach which leads to very high purity colloidal silica is by the sol-gel process. In this process, a high purity alkoxide, such as, tetramethoxy silane (TMOS) or tetraethoxy silane (TEOS), are used as the raw material. TMOS or TEOS is dissolved in methanol or ethanol first and then mixed with deionized (DI) water for hydrolysis, with NH₄OH used as the catalyst.

After the colloidal silica is formed, the solution is heated to a high temperature so that the ammonia and the organic solvent can be removed by evaporation (W. Stober, et al., J. Colloid Interface Sci., 26, 62 (1968)). The colloidal silica so processed has a very high purity because of the high purity of the raw materials.

However, this approach has several drawbacks. One is that the colloidal silica from this process is much more expensive because of the highly expensive raw materials. Secondly, large quantity of impure methanol or ethanol will be generated which is not environmental friendly. Finally, the colloidal can have high level of ammonia and organic solvent residual, which can be very undesirable for chemical mechanical polishing (CMP) applications.

Colloidal silica comes in different sizes and shapes. The main benefit of colloidal silica over fumed silica is that they can generate very small particles, as small as 5 to 10 nm. Also colloidal silica can be well dispersed to the primary particles while fumed silica particles are always aggregated. In the area of chemical mechanical polishing (CMP), this translates to very low defectivity and high removal rates on certain metals.

Most colloidal silicas, however, are quite impure. The commercially available Ludox colloidal silica from Grace has trace metals in double digit ppm ranges. This makes it unacceptable for chemical mechanical polishing (CMP) application.

Highly pure colloidal silicas can be made from TEOS or TMOS. However, these types of silica are very expensive because it requires pure raw materials and a complex manufacturing process and it generates significant amount of waste. For example, 3 parts of TEOS generates approximately 1 part of silica and two parts of impure ethanol. (TEOS is composed of 28% SiO2-72% EtOH).

The fumed silicas are generally quite pure. These are solid particles ranging from 75 to 300 nm mean particle size (MPS) with primary particles sized around 25 nm. But unlike colloidal silica they have to be made into chemical mechanical polishing (CMP) slurries by high shear grinding process using water, wetting and stabilizing agents. In addition these dispersions need filtration to remove large particles. Thus, although the fumed silica is low to moderate in cost, the final dispersion can be relatively expensive.

Accordingly, there is a need in industry for a low to moderate cost silica dispersion having a mean particle size that is comparable to that of colloidal silica which also has a purity comparable to that of fumed silica.

### SUMMARY OF THE INVENTION

It is an object of the present invention to form a low to moderate cost silica dispersion having a mean particle size that is comparable to that of colloidal silica but also having a purity comparable to that of fumed silica.

It is another object of the present invention is to provide a colloidal manufactured abrasive for chemical mechanical polishing (CMP) that provides the desired surface planarization, including high material removal rate, while minimizing the surface defects on substrates or semiconductor wafer surfaces.

It is still another object of this invention to form a high purity potassium silicate solution.

These objects are accomplished by using fumed silica as a raw material, but instead of dispersing it in water, dissolving it in an aqueous solvent containing an alkali metal hydroxide and thereafter, converting the resulting alkaline silicate solution into colloidal silica particles in a controlled manner to achieve the desired mean particle size and purity. Thus, for example, the desired mean particle size and purity was achieved by controlling the nucleation and particle growth rates which, in turn, was controlled by controlling the temperature, the cooling rate, the ion strength and the pH of the aqueous solution of the silicic acid that was obtained from the fumed silica after alkali treatment and ion exchange. The colloidal silica dispersion according to the present invention is a low to moderate cost silica dispersion having a mean particle size that is comparable to that of commercial colloidal silica. Further, because of its low metals content, the colloidal silica particles according to the present invention have purity comparable to that of commercial fumed silica particles. Still further, these high purity dispersions have no residual ethanol or methanol or amines present in the particles.

The present invention provides a method of manufacturing a colloidal silica dispersion. The method includes the steps of dissolving a fumed silica in an aqueous solvent containing an alkali metal hydroxide to produce an alkaline silicate solution, such as, a potassium silicate solution; removing the majority of alkali ions via ion exchange to produce a silicic acid solution; adjusting the temperature, concentration and pH of the silicic acid solution to values sufficient to initiate nucleation and particle growth; and cooling the silicic acid solution sufficiently to produce the colloidal silica dispersion. The colloidal silica particles in the colloidal silica dispersion have a mean particle size about 2 nm to about 100 nm.

The present invention further provides a method of chemical mechanical polishing a surface of a substrate. The method includes the step of contacting the substrate and a composition having a plurality of colloidal silica particles according to the present invention and a medium for suspending the particles. The contacting is carried out at a temperature and for a period of time sufficient to planarize the substrate.

The present invention still further provides a colloidal silica dispersion comprising colloidal silica particles having a particle size from about 2 to about 100 nm. This dispersion has less than 10 ppm of trace metal impurities excluding K, and less than 10 ppm residual methanol or ethanol.

The present invention also provides a potassium silicate solution having less than 10 ppm of trace metal impurities excluding K, and less than 10 ppm residual methanol or ethanol.

### BRIEF DESCRIPTION OF THE DRAWINGS

FIG. 1 is a schematic representation of the “sol-gel” process of colloidal silica (SiO₂).

FIG. 2 is a schematic representation of the preparation of a chemical mechanical polishing (CMP) slurry from fumed silica (SiO₂) according to the prior art methods.

FIG. 3 is a schematic representation of the preparation of colloidal silica prepared from fumed silica (SiO₂) according to the method of the present invention.

FIG. 4 shows particle size distribution (PSD) of a sample prepared according to the method of the present invention.

FIG. 5 is a comparison of the chemical mechanical polishing (CMP) performance of a commercial high purity colloidal silica (FUSO Chemicals company, sol-gel processed colloidal SiO₂) with a colloidal silica prepared from fumed (SiO₂) according to the method of the present invention.

### DETAILED DESCRIPTION OF THE INVENTION

The present invention provides a m thod of manufacturing a colloidal silica dispersion, including the steps of: dissolving a fumed silica in an aqueous solvent containing an alkali metal hydroxide to produce an alkaline silicate solution; removing majority of the alkali metal via ion exchange to produce a silicic acid solution, adjusting temperature, concentration and pH of the silicic acid solution to values sufficient to initiate nucleation and particle growth; and cooling the silicic acid solution to produce the colloidal silica dispersion.

The colloidal silica particles can be isolated from the colloidal silica dispersion to produce solvent free colloidal silica particles. However, the dispersion is typically used “as is” or by adding other ingredients, such as, organic solvents, additives and surfactants to produce a composition that is suitable for use for chemical mechanical polishing of surfaces of a substrate.

The colloidal silica particles can be isolated from the colloidal silica dispersion either by removing the aqueous solvent or, more preferably, by filtering the colloidal silica particles, and thereafter drying.

The colloidal silica particles prepared by the method of the present invention have a mean particle size (MPS) about 2 nm to about 100 nm.

Preferably, the colloidal silica particles have a total metals concentration of about 300 ppm or less. The metals can be Li, Na, K, Rb, Cs, Fr, Fe, Al, or any combinations thereof. More preferably, the concentration of these metals is about 100 ppm or less.

In the practice of the method of the present invention, fumed silica starting material is dissolved in an .g.&aqueous solvent, such as, an aqueous alkali, alcohol, or a combination thereof, to produce an alkali silicate solution. Then, majority of the alkali is removed by ion exchange so that the alkaline silicate solution is converted into a silicic acid solution. The temperature, the concentration and the pH of this solution, which is a silicic acid solution, is then adjusted to values such that the selected values cause the solution to initiate nucleation and allow the nucleated particles to form the colloidal silica dispersion.

Preferably, the temperature of the silicic acid solution before the start of the nucleation is about 5° C. to about 40° C.

Preferably, the concentration of the silicic acid in the silicic acid solution before the start of the nucleation is about 2 wt % to about 30 wt % of the silicic acid solution.

Preferably, the pH of the silicic acid solution is about 1.5 to about 5, preferably from 1.5 to about 4.0.

Preferably, the cooling rate of the silicic acid solution is about 5° C./min to about 100° C./min.

In another embodiment, the present invention provides a method of chemical mechanical polishing a substrate. The method includes the step of contacting the substrate and a composition having a plurality of colloidal silica particles according to the present invention and a medium for suspending the particles. The contacting is carried out at a temperature and for a period of time sufficient to planarize the substrate.

The particles can be suspended or dispersed in a variety of mediums to produce a polishing composition. For example, the particles may proportionately include a greater concentration of larger size or primary particles, with a lesser concentration of smaller size or secondary particles. The result of this size variation is an improved removal rate of surface impurities and controlled surface topography not provided by conventional polishes.

The composition can further include an additive selected from a carboxylic acid or a mixture of carboxylic acids present in a concentration of about 0.01 wt % to about 0.9 wt %; an oxidizer, present in a concentration of about 10 ppm to about 2,500 ppm and preferably, present in a concentration of about 10 ppm to about 1000 ppm; and a corrosion inhibitor, present in the range of about 10 ppm to about 1000 ppm.

In a preferred embodiment the primary particles, with a mean particle size from about 2 nm to about 100 nm.

The resulting composition can also be in the form of an emulsion, a colloidal suspension, a solution, and a slurry in which the particles are uniformly dispersed and are stable both in a basic or acidic pH environment and includes a surfactant.

In a preferred embodiment, a cationic, anionic, non-ionic, amphoteric surfactants or a mixture, more preferably a non ionic surfactant is used to significantly reduce surface removal rates at or above 50 ppm. The preferred non ionic surfactant is an alkoxylated non-ionic surfactant. The beneficial effects of the surfactants include a reduction in polishing friction.

Preferably an upper limit of about 1000 ppm because at this level, organic residue, defectivity is observed on the wafer surfaces. Therefore, a non-ionic surfacant is preferred because of its inert reactivity towards other films, such as those having Cu and Ta.

The particles in the composition also have a low level of trace metals such as Fe, Al, Li, Na, Rb, Cs, and F. Preferably, the colloidal silica particles have a total metals concentration of about 300 ppm or less. The metals can be Fe, Al, Li, Na, Rb, Cs, Fr, or any combinations thereof. More preferably, the concentration of these metals is about 100 ppm or less. Even more preferably 10 ppm or less except for K which can be used as stabilizer.

Preferably, silica particles of a surface area from about 20 m²/g to about 300 m²/g, include from about 1 wt % to 20 wt % of the total weight of the composition and the medium includes about 81 wt % to 99 wt % of the composition.

As described above, the medium can be water, an alkaline solution, an organic solvent or a mixture thereof, which can result in an emulsion, collodial suspension, or slurry.

The medium of the polishing composition can be an aqueous organic solvent, such as, an aqueous alcohol, an aqueous ketone, an aqueous ether, an aqueous ester, or a combination thereof. It can be the same or different than the aqueous organic solvent in the process of manufacturing a colloidal silica dispersion according to the present invention. The preferred medium is an aqueous alcohol, wherein the alcohol preferably is methanol, ethanol, propanol, butanol, ethylene glycol, propylene glycol, and mixtures thereof.

The pH of the polishing composition is maintained in the range of about 9.0 to about 11 or in acidic region of about 2.0 to about 4.0.

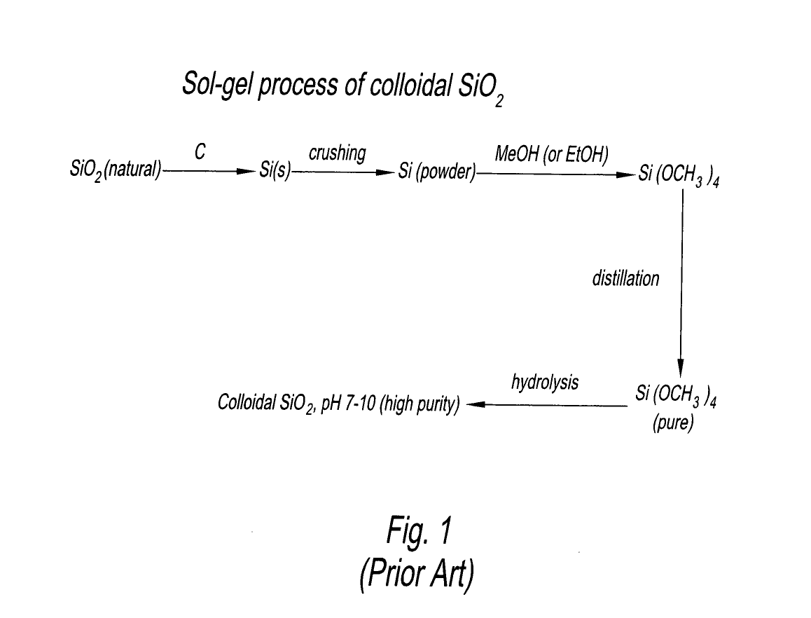

Referring to FIG. 1, a schematic representation of the “sol-gel” process of colloidal silica (SiO₂) according to the prior art methods is shown.

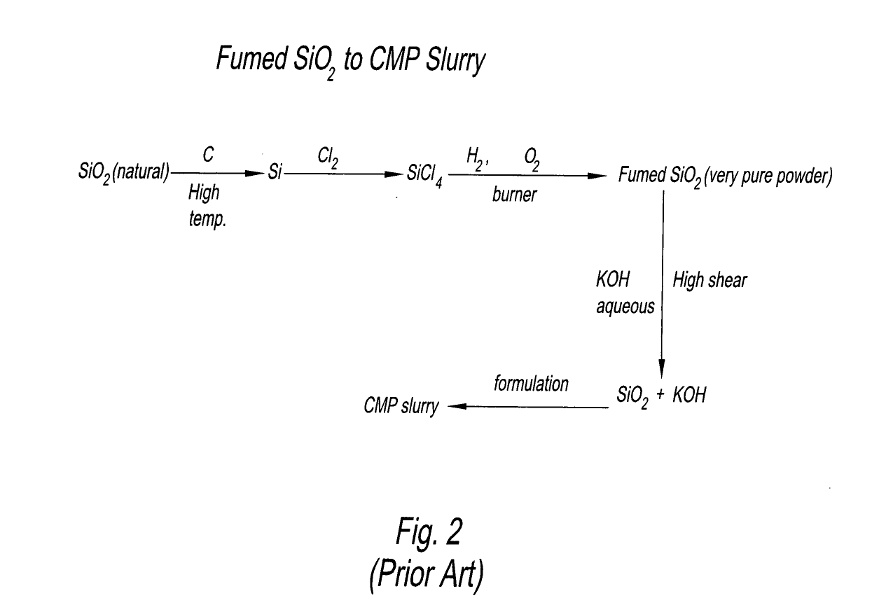

FIG. 2 is a schematic representation of the preparation of a chemical mechanical polishing (CMP) slurry from fumed silica (SiO₂) prepared according to the prior art methods.

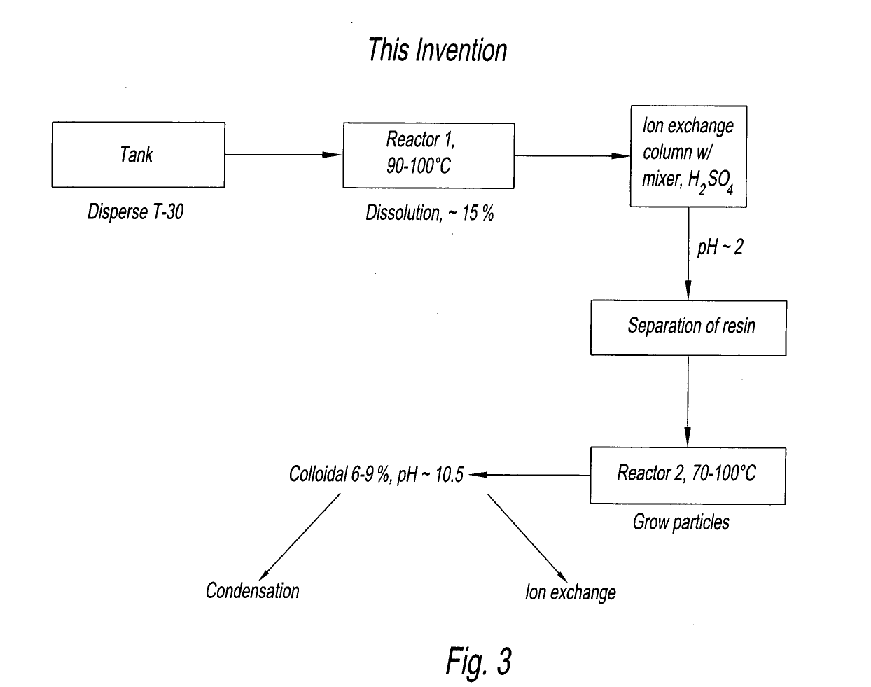

FIG. 3 is a schematic representation of the preparation of colloidal silica from fumed silica (SiO₂) according to the method of the present invention.

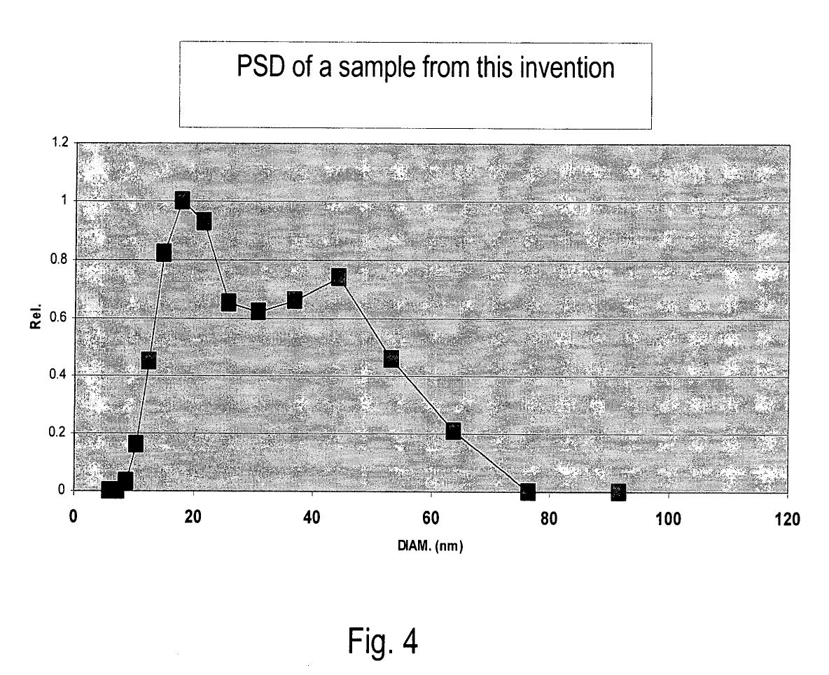

FIG. 4 shows the particle size distribution (PSD) of a sample prepared according to the method of the present invention.

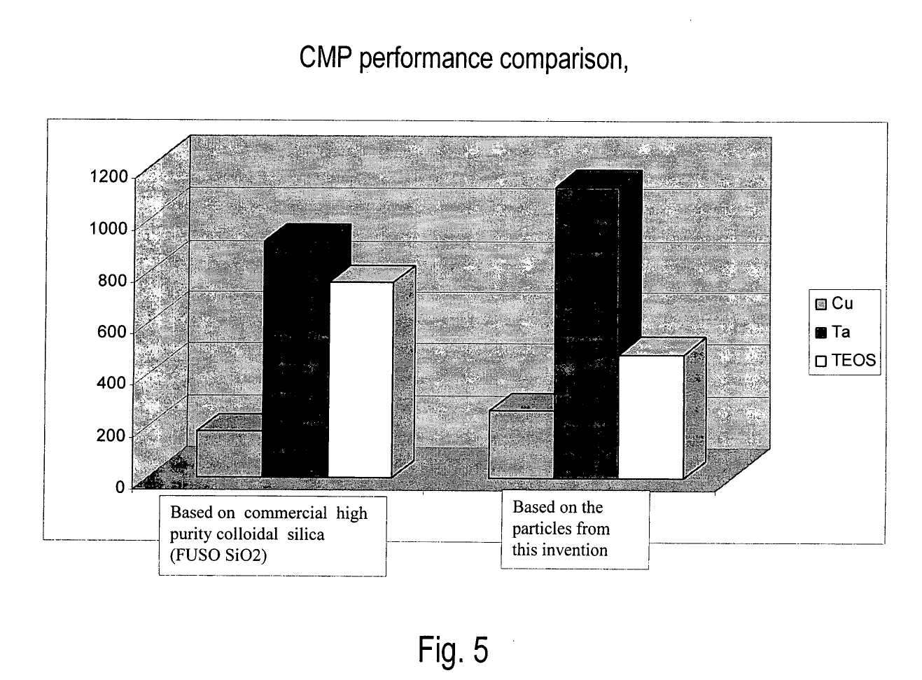

FIG. 5 is a comparison of the chemical mechanical polishing (CMP) performance of a commercial high purity colloidal silica (FUSO SiO₂) with a colloidal silica prepared from fumed (SiO₂) according to the method of the present invention.

The colloidal silica dispersion can be used as the polishing composition including a plurality of colloidal silica particles without isolating said colloidal silica particles from the colloidal silica dispersion.

Experimental

The colloidal silica manufacturing set up included a fumed silica dissolution system, a stirred deionization section for silicic acid production and a reactor for particle nucleation and growth.

High purity potassium silicate solution was produced by dissolving fumed silica in high purity potassium hydroxide. A mixture of KOH, DI water, and fumed silica was transferred into the reactor and heated to 90° C. Agitation was continued at this temperature until all silica was dissolved. The solution was cooled to room temperature and filtered using a Pall 0.5 um filter (0.5 micronmeters pore size filter).

The solid content of this high purity potassium silicate solution is 10-25 wt %, which has the KOH/SiO₂ less than 0.5 in terms of weight and the final pH is about 11-13.

Silicic acid was produced by passing high purity potassium silicate through an ion exchange resin column, which was prewashed with DI water. If necessary, the pH of the mixture can be re-adjusted at this point. The mixture was allowed to stir for 15 minutes after silicate addition to allow the silicic acid solution to equilibrate. The pH of the silicic acid solution was measured to be around 2.1 and adjusted as necessary.

Particle nucleation and growth is then initiated from the silicic acid by pH, temperature and time parameter adjustment. Various compounds can be used for pH adjustment, including but not limited to K compounds, alkali, salts, amines or other suitable pH adjusters. By controlling the levels of heal, stabilizer and perc (silicic acid) feeding sequences, a colloidal silica with broad particle size distribution (PSD) and a big narrow particle size distribution (PSD) particle for oxide chemical mechanical polishing (CMP) applications were made.

The particle size and particle size distributions were determined using dynamic light scattering NiComp or Malvern instrument. The amount of oversize was measured using an Accusizer. The pH was measured with a pH meter with a pH probe.

Fumed Silica Dissolution

T-30 particles made by Wacker Chemicals was used as the fumed silica source. T-30 was dissolved in KOH. At around 90° C. silica dissolved quickly.

Filtration is optional to remove the undissolved silica and prevent gel forming. The final solid % is about 21% and it contains about 15% SiO₂, which is suitable to ion exchange process to make perc for particle growth. The fumed silica powder, e.g., S-13 or T-30, supplied by Wacker, was added under high speed mixing to a solution of DO H₂O mixed with electronic grade KOH. After the powder was fully dispersed, the mixture was charged into a reactor and heated up to 95-10° C. under mixing. The silica powder dissolves gradually into a water clear K silicate solution at 5-25% SiO2 solid with KOH/SiO2 weight ratio ranging from 0.3-0.5. The final pH of the solution at room temperature was around 11.0-13.3. It is optional that this solution is filtered to remove any non-dissolvables.

Convertion of silicate into Perc (Silicic Acid)

Diluted with DI water or as is, the above solution was passed through a H+ type ion-exchange resin column, e.g., Amberlite IR 120, Rohm&Haas company. The volume ratio of the resin to the silicate solution was 0.5-2. After the ion exchange, the majority of the potassium ions were removed and the potassium silicate was converted into a high purity high transparency silicic acid which has a pH 1.5-3 and is 5-13 wt % in terms of SiO2 solid. This silicic acid was used in the following particle growth process as perc.

Particle Growth

The silicic acid was then subjected to a pH adjustment step with a control of time and temperature to control particle nucleation and growth. The final colloidal silica had a solid from 3-15 wt %, with mean particle size (MPS) being 10 nm to 100 nm and pH 8-12. It is optional that in order to grow different MPS particles of different particle size distribution (PSD), e.g., broad or narrow PSD, seeding technique is used. For seeding, a small portion of pre-made colloidal silica of small size, e.g., 10-20 nm, is charged into the reactor together with the potassium silicate solution before the perc is added or added gradually together with perc.

Post Treatment

The colloidal silica prepared as described herein above is cooled down to room temperature. Thereafter, it can be subjected to further processing. The colloidal silica prepared as described herein above can be further concentrated up to 40 wt % by an ultrafiltration technique, and/or can further de-ionized into a colloidal silica at low pH region (2-4) using the H+ type resin. It can also be dried to make high purity silica powder for applications in other areas.

In the present invention, the agent to dissolve fumed silica is not limited to KOH and can also be LiOH, NaOH, CsOH and others. Different anions, such as F⁻, (PO₄)³⁻ can also be doped.

The present invention has been described with particular reference to the preferred embodiments. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A method of manufacturing a colloidal silica dispersion, comprising the steps of:
dissolving a fumed silica in an aqueous solvent comprising an alkali metal hydroxide to produce an alkaline silicate solution;
removing said alkali metal via ion exchange to convert said alkaline silicate solution to a silicic acid solution;
adjusting temperature, concentration and pH of said silicic acid solution to values sufficient to initiate nucleation and particle growth upon cooling; and
cooling said silicic acid solution at a rate sufficient to produce said colloidal silica dispersion.

2. The method of claim 1, further comprising the step of:
isolating colloidal silica particles from said colloidal silica dispersion.

3. The method of claim 2, wherein said step of isolating is carried out by removing said aqueous solvent.

4. The method of claim 2, wherein said step of isolating is carried out by filtering said colloidal silica particles and drying.

5. The method of claim 2, wherein said colloidal silica particles have a mean particle size about 2 nm to about 100 nm.

6. The method of claim 5, wherein said colloidal silica particles have a total metals concentration of about 300 ppm or less.

7. The method of claim 6, wherein said metals are selected from the group consisting of: Li, Na, K, Rb, Cs, Fr, Fe, Al, and any combinations thereof.

8. The method of claim 7, wherein said metals concentration is about 100 ppm or less.

9. The method of claim 1, wherein said temperature is about 5° C. to about 40° C.

10. The method of claim 1, wherein said concentration is about 2 wt % to about 30 wt % of the silicic acid solution.

11. The method of claim 1, wherein said pH of said alkaline silicate solution is from about 11 to about 13 and said silicic acid solution is from about 1.5 to about 5.

12. The method of claim 1, wherein said cooling rate of said silicic acid solution is about 5° C./min to about 100° C./min.

13. The method of claim 1, wherein said alkali metal hydroxide is potassium hydroxide.

14. A method for chemical mechanical polishing a surface of a substrate comprising the step of:
contacting said substrate and a composition comprising a plurality of colloidal silica particles and a medium for suspending said particles; wherein said colloidal silica particles are prepared by dissolving a fumed silica in an aqueous solvent comprising an alkali metal hydroxide to produce a alkaline silicate solution, removing said alkali metal via ion exchange to convert said alkaline silicate solution to a silicic acid solution, adjusting temperature, concentration and pH of said silicic acid solution to values sufficient to initiate nucleation and particle growth, and cooling said silicic acid solution at a rate sufficient to produce a colloidal silica dispersion; and isolating said colloidal silica particles from said colloidal silica dispersion to produce colloidal silica particles having a mean particle size about 2 nm to about 100 nm and metals selected from the group consisting of: Li, Na, K, Rb, Cs, Fr, Fe, Al, and any combinations thereof at a total metals concentration of about 300 ppm or less;
wherein said contacting is carried out at a temperature and for a period of time sufficient to planarize said substrate.

15. The method of claim 14, wherein said colloidal silica particles comprise from about 19 wt % to about 24 wt % of the total weight of said composition.

16. The method of claim 14, wherein said colloidal silica particles have a surface area from about 20 m²/g to about 300 m²/g.

17. The method of claim 14, wherein said composition further comprises a surfactant selected from the group consisting of:
anionic, cationic, non-ionic and amphoteric surfactants and a mixture thereof.

18. The method of claim 17, wherein said surfactant is an alkoxylated non-ionic surfactant.

19. The method of claim 14, wherein said composition further comprises at least one additive selected from the group consisting of:
carboxylic acid, at a concentration of about 0.01 wt % to about 0.9 wt %;
oxidizer, at a concentration of about 10 ppm to about 2500 ppm; and
corrosion inhibitor, at a concentration of about 10 ppm to about 1000 ppm.

20. The method of claim 14, wherein said composition is in a form selected from the group consisting of:
an emulsion, colloidal suspension, solution and slurry.

21. The method of claim 14, wherein said medium is from about 1 wt % to about 86 wt % of the total weight of said composition.

22. The method of claim 14, wherein said medium has a pH about 6.7 to about 7.6.

23. The method of claim 14, wherein said medium is selected from the group consisting of: water, an organic solvent and a mixture thereof.

23. The method of claim 14, wherein said colloidal silica dispersion is used as the chemical mechanical polishing composition without isolating the colloidal silica particles from the colloidal silica dispersion.

25. The method of claim 14, wherein said alkali metal hydroxide is potassium hydroxide.

26. A colloidal silica dispersion comprising colloidal silica particles having a particle size from about 2 to about 100 nm, wherein said colloidal silica dispersion has less than 10 ppm of trace metal impurities excluding K, and have less than 10 ppm residual methanol or ethanol.

27. The colloidal silica dispersion according to claim 26, wherein the colloidal silica dispersion is prepared by a method comprising the steps of:
dissolving a fumed silica in an aqueous solvent comprising an alkali metal hydroxide to produce an alkaline silicate solution;
removing the alkali metal via ion exchange to generate a silicic acid solution; and
adjusting temperature, concentration and pH of said silicic acid solution to values sufficient to initiate nucleation and particle growth; and
cooling said silicic acid solution at a rate sufficient to produce said colloidal silica dispersion.

28. The colloidal silica dispersion according to claim 26, wherein said colloidal silica dispersion is prepared by a method comprising the step of:
suspending said colloidal silica particles in an aqueous solvent.

29. A method of chemical mechanical polishing a surface of a substrate comprising the step of:
contacting said substrate and a colloidal silica dispersion according to claim 26, wherein said contacting is carried out at a temperature and for a period of time sufficient to planarize said substrate.

30. A potassium silicate solution having less than 10 ppm of trace metal impurities excluding K, and less than 10 ppm residual methanol or ethanol.
